(19) United States
(12) Patent Application Publication
(10) Pub. No.: US 2005/0028113 A1
(43) Pub. Date: Feb. 3, 2005

(54) Process translation tool for analog/RF IP reuse

(75) Inventors: Yiqun Lin, Melbourne, FL (US); Jeffrey M. Shoemaker, Indialantic, FL (US)

Correspondence Address: Fogg and Associates, LLC, P.O. Box 581339, Minneapolis, MN, 55458-1339, US

(73) Assignee: INTERSIL AMERICAS INC.

(21) Appl. No.: 10/633,125

(22) Filed: Aug. 1, 2003

(51) Int. Cl. G06F 17/50

(52) U.S. Cl. 716/3

(57) ABSTRACT

A translation tool for the design of integrated circuits. In one embodiment, a method comprises translating select device parameters in a first database associated with a first process to device parameters in a second database associated with a second process and displaying a design based on the device parameters in the second database.

### TECHNICAL FIELD

The present invention relates generally to integrated circuit design and in particular to an automatic design translation tool.

### BACKGROUND

The use of computer design simulation programs to aid in the design of integrated circuits is commonly used in the electronic design automation (EDA) industry. Typically a design simulates a process in forming a desired integrated circuit. Often it is desired to migrate analog and RF intellectual Property (IP) from one process to another process for various reasons. Such reasons include, cost reduction, performance improvement, capacity improvement and IP up-integration into other systems.

Traditionally, the migration of analog and RF IP across different processes is accomplished with conventional hand translation, manual circuit retuning and calibration, and drawing layouts from scratch by analog and RF design engineers. These are very time consuming, tedious and costly tasks. There is a need in the art for an improved method of migrating analog and RF IP across different processes in designing integrated circuits.

For the reasons stated above and for other reasons stated below which will become apparent to those skilled in the art upon reading and understanding the present specification, there is a need in the art for an improved method of migrating analog and RF IP across different processes in designing integrated circuits

### Summary

The above-mentioned problems and other problems are resolved by the present invention and will be understood by reading and studying the following specification.

In one embodiment, a method of designing devices in integrated circuits is disclosed. The method comprises translating select device parameters in a first database associated with a first process to device parameters in a second database associated with a second process and displaying a design based on the device parameters in the second database.

In another embodiment, a method of translating an integrated circuit design in a first process to a second process is disclosed. The method comprises setting translations options. Reading original schematic information. Translating schematic information. Reading original layout information. Translating layout information and outputting parameters of translated schematic and layout information.

In further another embodiment, a computer-readable medium including instructions for simulating the design of an integrated circuit from one process to another process is disclosed. The computer-readable medium includes instructions for processing translation options. Reading original schematic information. Translating schematic information. Reading original layout information. Translating layout information and outputting parameters of translated schematic and layout information.

### BRIEF DESCRIPTION OF THE DRAWINGS

The present invention can be more easily understood and further advantages and uses thereof more readily apparent, when considered in view of the description of the preferred embodiments and the following figures in which:

FIG. 1 is a flow chart illustrating a process translation of one embodiment of the present invention;

FIG. 2, is a flow chart illustrating the set up and steps of a translation of one embodiment of the present invention;

FIG. 3 is a GUI of one embodiment of the present application;

FIG. 4 is an illustration of a partial schematic diagram before translation of one embodiment of the present invention;

FIG. 5 is an illustration of a partial schematic diagram after translation in one embodiment of the present invention;

FIG. 6 is a display illustrating original information of one embodiment of the present invention;

FIG. 7 is a translated display of one embodiment of the present invention;

FIG. 8 is an illustration of a layout before translation of one embodiment of the present invention;

FIG. 9 is an illustration of a layout after translation of one embodiment of the present invention;

FIG. 9A is an illustration of the number of layer before translation in one embodiment of the present invention;

FIG. 9B is an illustration of an additional layer after translation in one embodiment of the present invention; and

FIG. 10 is a top level layout illustration of one embodiment of the present invention.

In accordance with common practice, the various described features are not drawn to scale but are drawn to emphasize specific features relevant to the present invention. Reference characters denote like elements throughout Figures and text.

### DETAILED DESCRIPTION

In the following detailed description of the preferred embodiments, reference is made to the accompanying drawings, which form a part hereof, and in which is shown by way of illustration specific preferred embodiments in which the inventions may be practiced. These embodiments are described in sufficient detail to enable those skilled in the art to practice the invention, and it is to be understood that other embodiments may be utilized and that logical, mechanical and electrical changes may be made without departing from the spirit and scope of the present invention. The following detailed description is, therefore, not to be taken in a limiting sense, and the scope of the present invention is defined only by the claims and equivalents thereof.

Embodiments of the present invention provide a translation tool that migrates analog and RF (intellectual property) IP across integrated circuits processes to boost design productivity. This is accomplished by translating all databases including schematic and layout designs from one process to another. For example, the translation tool can translate original schematic and layout that were designed in one process to a schematic and layout database in another process. The new schematic database preserves almost all critical component parameters such as resistance, capacitance, transistor size and all original connectivity and is simulation ready right after the translation. In one embodiment of the present invention, the translated layout database preserves all mapped layers and devices with proper location and conductivity and is ready to restore the layout connectivity from schematic by using a connectivity-based layout tool. The translation tools of the present invention also provide means for designers to probe and compare the original design component parameters easily in the new design database and environment without having to open the original design. An example of a translation process in which the current invention is applicable is the translation of one wireless local area network (WLAN) transceiver from an internal pure silicon BiCMOS process “process 1” to another SiGe BiCMOS process “process 2” with exact product specification requirements.

The present invention maps similar devices and mask layers from one process to another. The device characteristics, models and component description format (CDF) parameters have to be carefully evaluated so that similar components and CDF parameters can be mapped. Also, the processes have to be carefully examined so similar mask layers can be mapped as well.

One common problem is resistor sheet rho (or area resistance) and capacitor area capacitance normally doesn't match between processes, so in one embodiment of the present invention there are options to preserve either resistance/capacitance or geometry. In particular, in order to keep electrical consistency of the schematic design, the resistance and capacitance are typically preserved and in regards to layouts, the geometry, such as length and width, are preserved.

In various embodiments of the present invention, higher-level schematic requirements are included to keep conductivity in the schematic with correct device rotation, polarity, program node and inherited connection as well as adding extra or removing redundant wires automatically. These higher level embodiments, layout requirements typically include correct device layout placement location and rotation, ability to use connectivity-based layout editing tool to restore the conductivity from the schematic after translation, and automatic grid and diagonal line mode check correction.

After translation, there are times designers want to go back to check the original design CDF parameters. Embodiments of the present invention allow the designers to do this without launching a separate design session and opening the original design in a different window. Instead, in other embodiments, the original device CDF parameters are preserved in the translated design as data base properties. These properties can then be displayed side by side with the new CDF parameters for comparison reasons without opening a separate design session.

Limitations are generally identified before implementation, so they can be dealt with later. Limitations may include unmatched devices, CDF parameters, nodes and mask layers. In one embodiment, reports are generated when a limitation is encountered during the translation process.

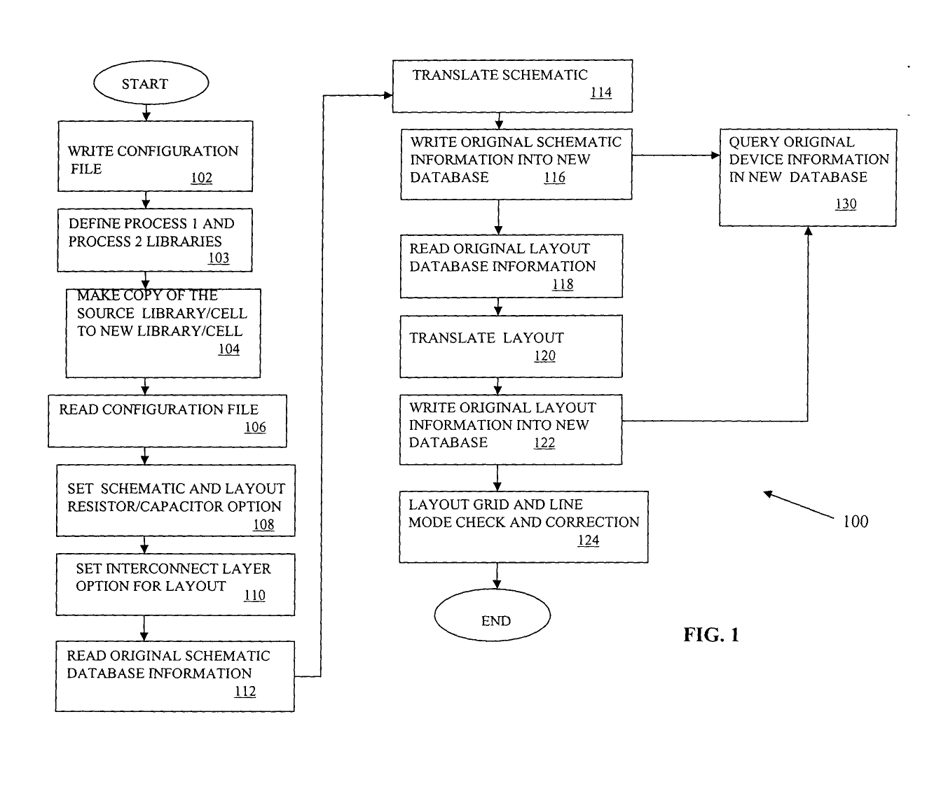

FIG. 1, is a flow chart 100 illustrating a process translation of one embodiment of the present invention. The process starts by creating a configuration file (102). The configuration file describes the translation requirements. It may include device mapping, terminal mapping, insertion origin, polarity and rotation, mask layer mapping, parameter mapping and functions to be triggered after translation, resistor/capacitor options and interconnect layer options. Process 1 and process 2 libraries are defined (103). The source library/cell is copied to a new library (cell) (104). The configuration file is then read (106). Schematic and layout resistor/capacitor option is set (108). Interconnect later option for layout is set (110). The original schematic database information is read (112). The schematic is translated by a predefined code (114). The original schematic information is written into a new database (116). The original device information in the new data base can be queried by a designer to obtain original design information (130). The original layout database information is read (118). The layout is then translated by a predefined code (120). The original layout information is then written into a new database (122). The original device information in the new data base can again be queried later by a designer to obtain original design information (130). The layout grid and line mode are check and corrected (124).

An example of a process translation is the translation between process 1 and process 2. Examples of devices translated between process 1 and process 2 are provided in Table 1.

TABLE 1

| PROCESS 1 DEVICES | PROCESS 2 DEVICES |
|---|---|
| Moscap | Moscap |
| momcap, momcaprf, 3rf, 4rf | mim, mix |
| rtcr1, 2, 3, 4 | Respect |
| rpp, rpp3 | respd, respdx |
| Rpoly | Resnd |
| rpldde, rpldde3 | respc, respcx |
| npnrf1, npnrf2 | npd0p32 |
| Npnmv1 | npd0p44 |
| npnhv1, npnhv2 | npd0p44 |
| bonpad2, 3, 4 | bondpad, bondpadx |
| Nmos | nfeti3 |
| noms4 | nfeti4 |
| noms5 | nfeti5 |
| Pmos | pfet |
| Desdrf | var |
| desdrf_lvs | varx |
| diode3 | var |
| Desd | var |
| Subtie | subcx |
| rlvs1, 2, 3 | m1res, m2res, mtres |
| Inductors | dropped |
| fuse | dropped |

Examples of layers translated between process 1 and process 2 are shown in Table 2.

TABLE 2

| PROCESS 1 LAYERS | PROCESS 2 LAYERS |
|---|---|
| Nitride | RX |
| Met1 | M1 |
| MET2 | M2 |
| MET3 | MT OR AM |
| Contact | CA |
| Via1 | V1 |
| Via2 | V2 or V2 + MT + AV |
| Poly | PC |
| Subp | SXCUT |

Know limitations of process 1 to process 2 include: 1. The device parameter limits are different between process 1 and process 2. For example, capacitor minimum 1/w in process 1 is 5 um, while in process 2 they are 8 um, so all process 1 min caps with 1/w less than 5 um will be set to 8 um after translation. The npn device maximum number of stripes in process 1 is 6, while in process 2 it is 2. So any number of strips larger than 2 in process 1 will be set to 2 in process 2. There is no limitation in npn emitter width, but process 2 imposes a 50 um maximum, so any emitter width larger than 50 um in process 1 will be set to 50 um in process 2. 2. All Pwell, NBL and substrate nodes will be mapped between process 1 and process 2 devices if applicable, however, in some cases, there are no correspondence, then the process 2 device will use the default Pwell, NBL and substrate node connection. In one embodiment you must manually connect them for the design.

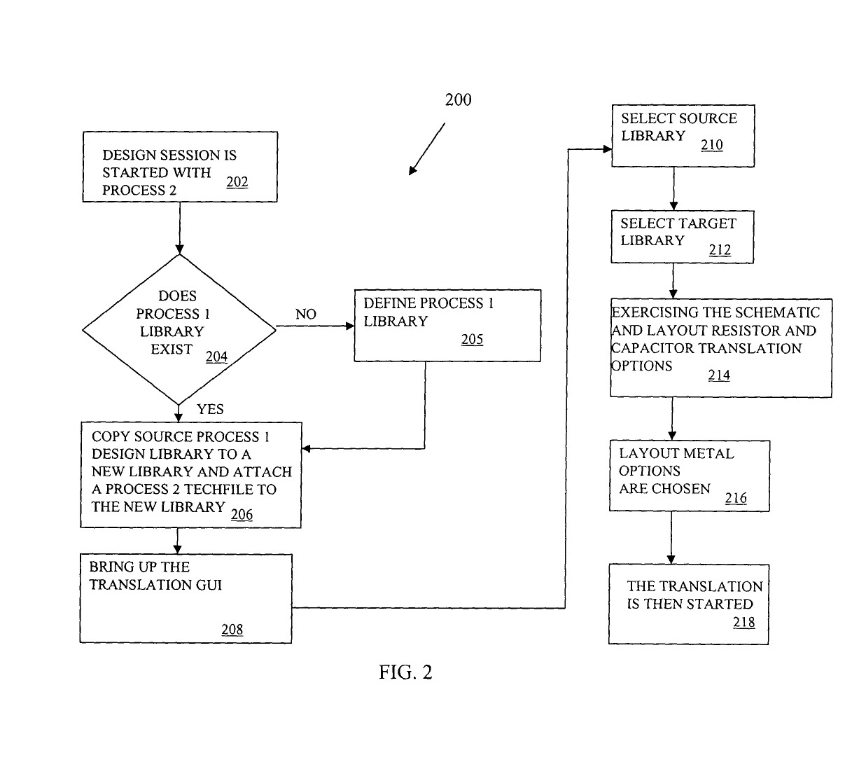

Referring to FIG. 2, a flow chart 200 illustrating the setup and steps for a process 1 to process 2 translation of one embodiment of the present invention is illustrated. As illustrated, a design framework session is started (202). It is determined if a process 1 library exists (204). If it does not exist, it is defined (205) with the use of a “library manager->edit->library path.” Once the process 1 libraries exist, the library manager is used to make a copy of the source process 1 design library to a new library and attach a new process techfile to the new library (206). For example, a process 1 design library “Usrlib”, can be copied and named “Usrlib-copy20,” then a techfile process 2 is attached to “Usrlib-copy20.” Then the process translation menu is chosen to bring up the translation GUI (208). The source library is then selected (210). The source library is the original process 1. It will be read throughout the translation process. The source library must be attached to the process 1 library. In this example, the source library is “Usrlib.” The target library is then selected (212). The target library is the library that will be changed and converted to the process 2 design. The target library must be attached to the process 2 library. In this example the target library is “Usrlib_copy20.” The schematic and layout resistor and capacitor translations options are exercised (214). As discussed above, the resistance/capacitance and size of the resistors and capacitors can be keep the same through the translation or modified per the application. The default is that the resistance and capacitance are kept the same for schematics and the size is kept the same for layouts. Next, the layout metal portion M3 to MT or to AM options are selected (216). The default option in this embodiment is M3 to MT. The translation is then started (218).

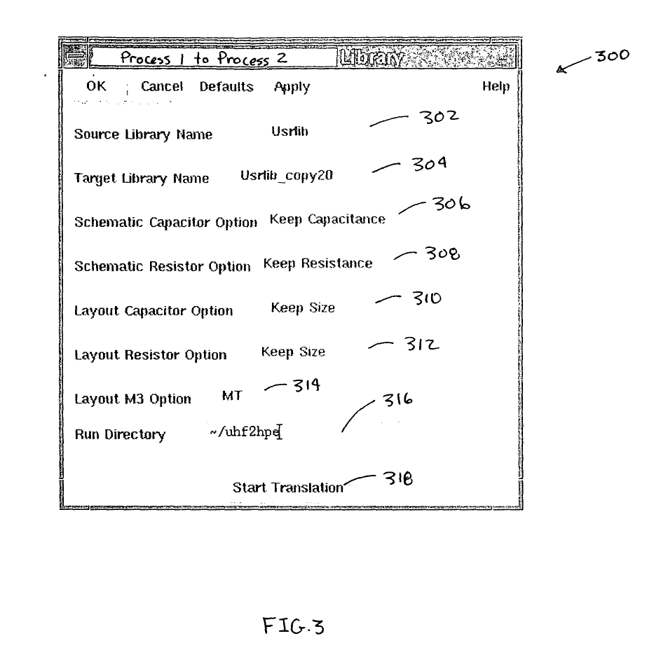

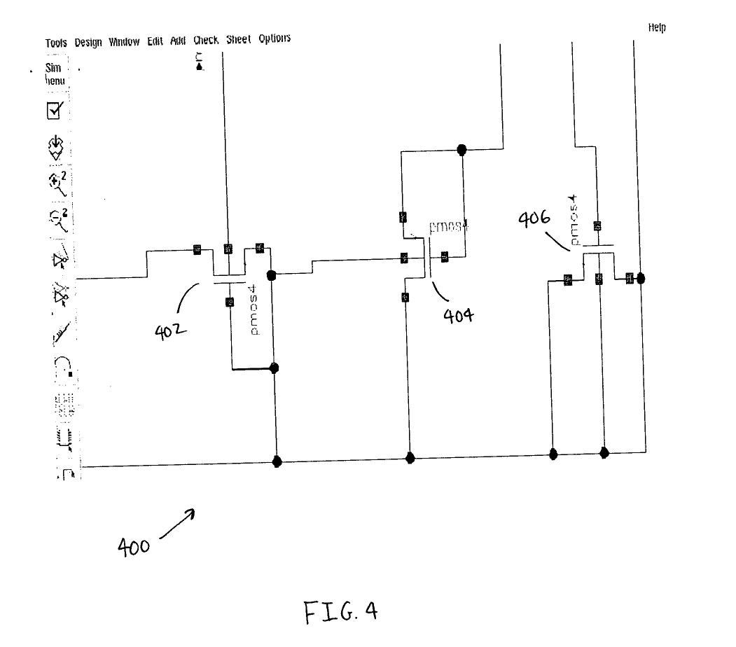

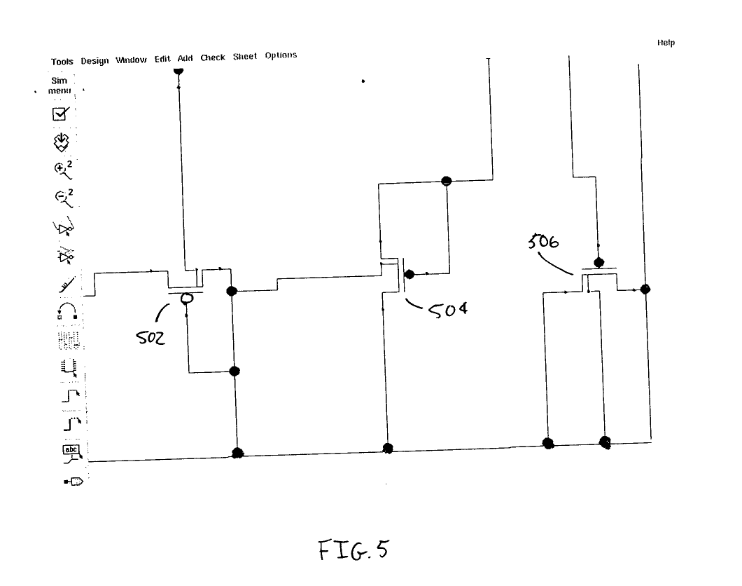

An example of a graphical user interface (GUI) 300 to initiate a translation of one embodiment of the present invention is illustrated in FIG. 3. As illustrated, the GUI 300 includes inputs for; source library name 302, target library name 304, schematic capacitor option 306, schematic resistor option 308, layout capacitor option 310, layout resistor option 312, layout M3 option 314 and run directory 316. Also illustrated is a start translation activation bar 318. Referring to FIG. 4, an example of a partial schematic diagram of a process 1 before translation is shown. As illustrated, the schematic diagram 400 includes transistors 402, 404 and 406. FIG. 5 illustrates an example of an schematic diagram 500 after translation. As illustrated, this example includes transistors 502, 504 and 506.

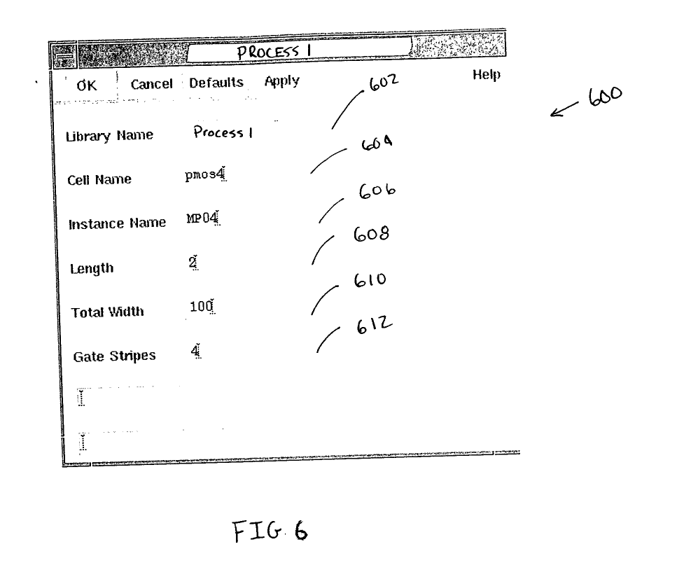

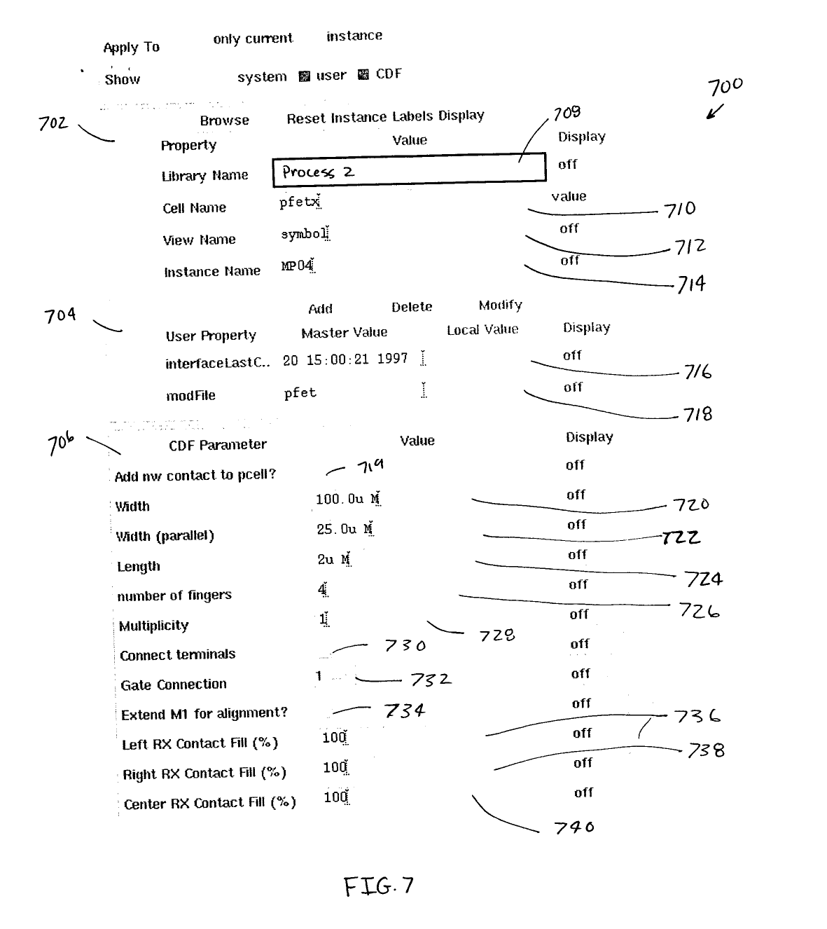

FIG. 6 is an original display 600 of original process 1 information of one embodiment of the present invention. As illustrated this display 600 includes the library name 602, the cell name 604, the instance name 606, the length 608, the total width 610 and the gate stripes 612. Referring to FIG. 7, a translated display 700 of one embodiment is illustrated. The translated display 700 of this embodiment includes a label display 702, a tracking display 704 and a CDF parameter display 706. The label display 702 includes the library name 708, cell name 710, view name 712 and instance name 714. The tracking display includes the interface last time and date 716 and modification file 718. The CDF parameter display 706 includes a request to add nw contact to pcell 719, width 720, width (parallel) 722, length 724, number of fingers 726, multiplicity 728, connect terminals 730, gate connection 732, extend M1 for alignment? 734, left RX contact fill (%) 736, right RX contact fill (%) 738, center RX contact fill (%) 740. Please note that the instance name 606 of the original display 600 of FIG. 6 is the same as the instance name 714 of the translated display 700 of FIG. 7 in these embodiments.

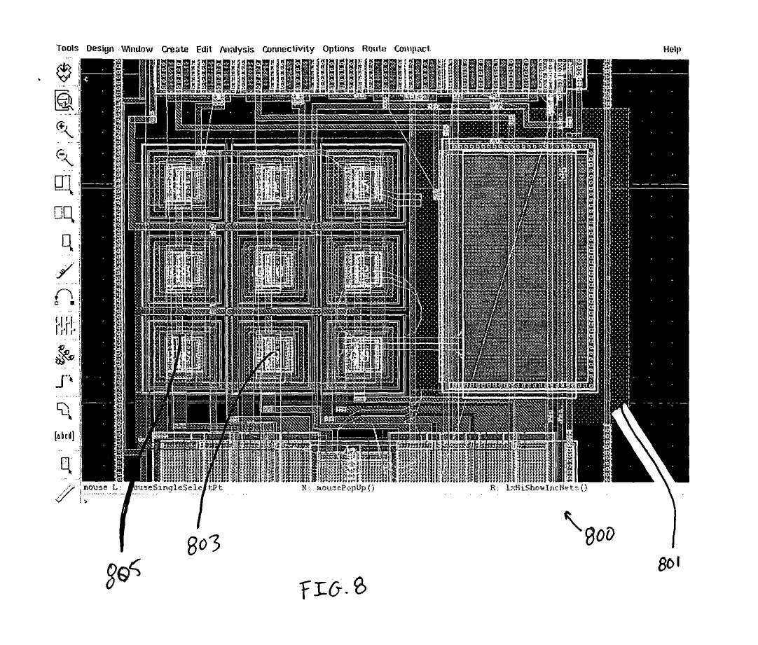

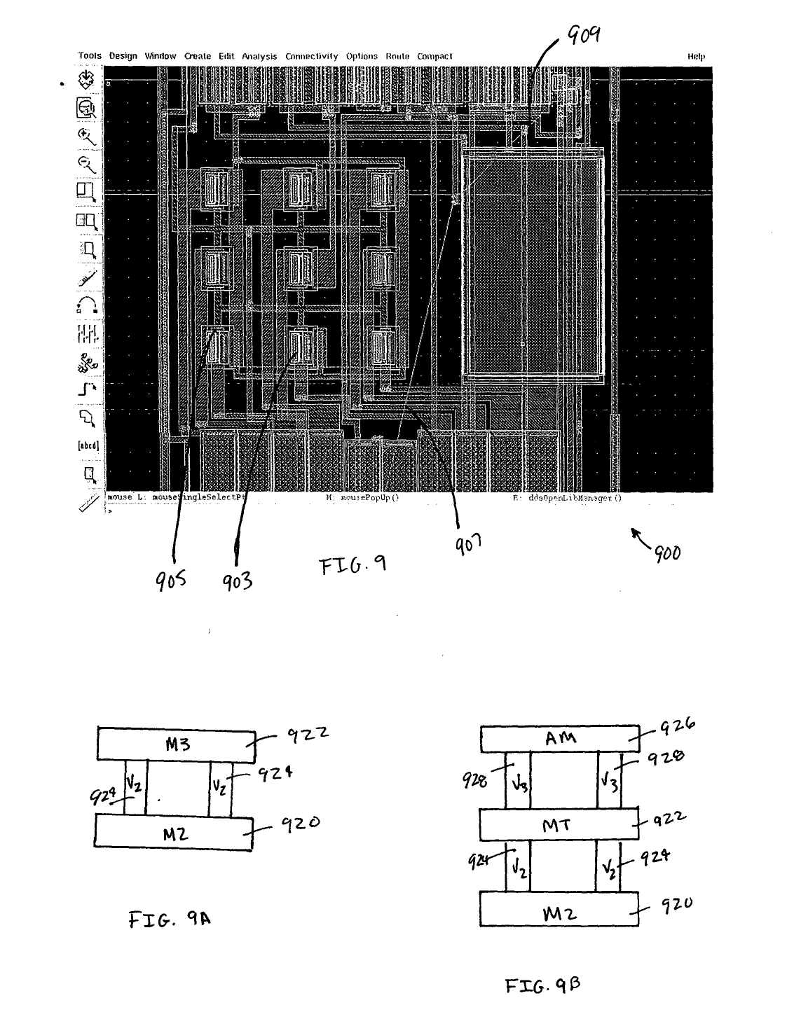

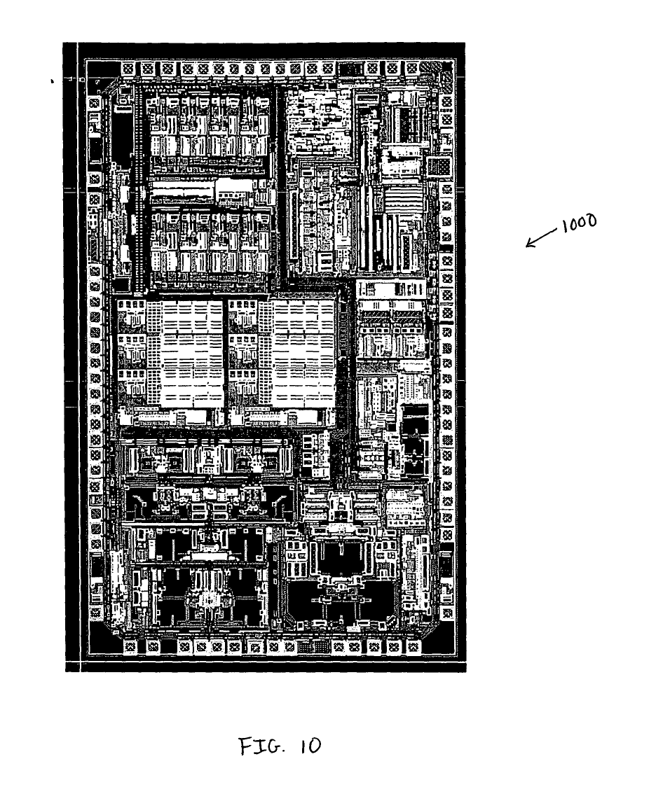

An example of a layout 800 before translation is illustrated in FIG. 8. FIG. 8 illustrates a device location, rotation and polarity generally at 803, an interconnect at 805 and an unnecessary layer at 801. FIG. 9 illustrates an example of an after layout 900 after the translation has been completed. As illustrated device layout location, rotation and polarity at 903 are preserved. Moreover interconnects, such as 905 are preserved and unnecessary layers are dropped (i.e. there is no corresponding layer to layer 801 of FIG. 8 in FIG. 9). Moreover, conductivity is restored. For example, please refer to 907 and 909 of FIG. 9. In addition, additional layers are added as an interconnect option if required. An example of this is illustrated in FIGS. 9a and 9b. FIG. 9A illustrates two metal layers M2 920 and N3 922 coupled to each other by vias 924 before a translation. FIG. 9B illustrates three layers M2 920, MT 922 and AM 926 coupled to each other respectively by vias 924 and 928 after translation. Referring to FIG. 10, an example of a top level layout 1000 of an integrated circuit after translation is shown.

As described above, embodiments of the present invention map mask layers and map device parameters between two different processes. Some embodiments have callbacks that can be triggered. Some embodiments provide an option to add extra interconnect layers. Further embodiments, allow for the addition and deletion of wires automatically to keep the schematic design electrically correct. Moreover, other embodiments preserve instance names in both schematic and layout so that layout conductivity can be restored after translation. Still further embodiments, automatically grid and line mode (diagonal) check and provide corrections.

Although specific embodiments have been illustrated and described herein, it will be appreciated by those of ordinary skill in the art that any arrangement, which is calculated to achieve the same purpose, may be substituted for the specific embodiment shown. This application is intended to cover any adaptations or variations of the present invention. Therefore, it is manifestly intended that this invention be limited only by the claims and the equivalents thereof.

1. A method of designing devices in integrated circuits, the method comprising:
translating select device parameters in a first database associated with a first process to device parameters in a second database associated with a second process; and
displaying a design based on the device parameters in the second database.

2. The method of claim 1, wherein the select device parameters are at least one of schematic and layout parameters.

3. The method of claim 1, wherein the select device parameters are schematic parameters, the schematic parameters including resistances, the method further comprising:
retaining select resistance parameters of the first database in the second database.

4. The method of claim 1, wherein the select device parameters are schematic parameters, the schematic parameters including capacitances, the method further comprising:
retaining select capacitance parameters of the first database in the second database.

5. The method of claim 1, wherein the select device parameters are layout parameters, the layout parameters including device geometry parameters, the method further comprising:
retaining select geometry parameters of the first database in the second database.

6. The method of claim 1, wherein the design displayed is a schematic design.

7. The method of claim 1, wherein the design displayed is a layout display.

8. The method of claim 1, wherein translating select device parameters further comprises:
mapping mask layers.

9. The method of claim 1, wherein translating select device parameters further comprises:
selectively adding extra interconnect layers.

10. The method of claim 1, wherein translating select device parameters further comprises:
preserving instance names between the first and second databases.

11. The method of claim 1, wherein translating select device parameters further comprises:
checking and correcting grid and line mode automatically.

12. The method of claim 1, further comprising:
displaying an original design based on the device parameters in the first database along side the design based on the translated device parameters in the second database.

13. The method of claim 12, wherein a separate design session is not required to display the original design based on the parameters in the first database.

14. A method of translating an integrated circuit design in a first process to a second process, the method comprising:
setting translations options;
reading original schematic information;
translating schematic information;
reading original layout information;
translating layout information; and
outputting parameters of translated schematic and layout information.

15. The method of claim 14, further comprising:
copying a source library to a new process library.

16. The method of claim 14, further comprising:
selecting a target library, wherein the target library contains information translated to the second process.

17. The method of claim 14, further comprising:
writing original schematic information into a new data base.

18. The method of claim 14, further comprising:
adding and deleting wires automatically to keep electrically correct schematic designs.

19. The method of claim 14, further comprising:
writing original layout information into a new database.

20. The method of claim 14, further comprising:
mapping mask layers.

21. The method of claim 14, further comprising:
selectively adding extra interconnect layers.

22. The method of claim 14, further comprising:
checking and correcting grid and line mode automatically.

23. The method of claim 14, further comprising:
restoring conductivity in a translated layout from schematic information.

24. The method of claim 14, further comprising:
preserving interconnect lines.

25. The method of claim 14, further comprising:
generating a report when a limitation is encountered during a translation process.

26. The method of claim 14, further comprising:
creating a configuration file; and
reading the configuration file.

27. The method of claim 26, wherein creating a configuration file further comprises at least one of the functions in the group of functions comprising, mapping devices, mapping terminals, mapping mask layers, mapping parameters, inserting original device parameters, creating polarity and rotation, defining resistor and capacitor options, defining interconnect options and defining functions to be triggered after translation.

28. The method of claim 14, further comprising:
displaying a translated schematic design.

29. The method of claim 28, further comprising:
displaying an original schematic design based on the original schematic information along side the translated schematic design.

30. The method of claim 14, further comprising:
displaying a translated layout design.

31. The method of claim 30, further comprising:
displaying an original layout design based on the original layout information along side the translated layout design.

32. The method of claim 14, wherein setting translation options further comprises at least one of an option from a group of options comprising, setting select resistances to remain unchanged, setting select capacitances to remain unchanged, setting select geometries to remain unchanged and a layout interconnect option.

33. The method of claim 32, wherein setting translation options is done with the use of a graphic user interface.

34. The method of claim 14, further comprising:
displaying the outputted parameters of the translated schematic and layout information.

35. The method of claim 34, further comprising:
displaying original parameters associated with the original schematic and layout information along side the outputted parameters.

36. The method of claim 35, wherein the side by side display is created without having to start a separate design session.

37. A computer-readable medium including instructions for simulating the design of an integrated circuit from one process to another process comprising:
processing translation options;
reading original schematic information;
translating schematic information;
reading original layout information;
translating layout information; and
outputting parameters of translated schematic and layout information.

38. The computer-readable medium of claim 37, further comprising:
copying a source library to a new process library.

39. The computer-readable medium of claim 37, further comprising:
selecting a target library, wherein the target library contains information translated to the second process.

40. The computer-readable medium of claim 37, further comprising:
writing original schematic information into a new data base.

41. The computer-readable medium of claim 37, further comprising:
adding and deleting wires to keep electrically correct schematic designs.

42. The computer-readable medium of claim 37, further comprising:
writing original layout information into a new database.

43. The computer-readable medium of claim 37, further comprising:
mapping mask layers.

44. The computer-readable medium of claim 37, further comprising:
selectively adding extra interconnect layers.

45. The computer-readable medium of claim 37, further comprising:
checking and correcting grid and line mode automatically.

46. The computer-readable medium of claim 37, further comprising:
restoring conductivity in a translated layout from schematic information.

47. The computer-readable medium of claim 37, further comprising:
preserving interconnect lines.

48. The computer-readable medium of claim 37, further comprising:
generating a report when a limitation is encountered during a translation process.

49. The computer-readable medium of claim 37, further comprising:
displaying the outputted parameters of the translated schematic and layout information.

50. The computer-readable medium of claim 37, wherein setting translation options further comprises at least one of an option from a group of options comprising, setting select resistances to remain unchanged, setting select capacitances to remain unchanged, setting select geometries to remain unchanged and a layout interconnect option.
